(19) United States
(12) Patent Application Publication
(10) Pub. No.: US 2018/0093806 A1
(43) Pub. Date: Apr. 5, 2018

(54) BUDDY CLIP

(71) Applicant: Avery Dennison Corporation, Glendale, CA (US)

(72) Inventors: Kyle FOSSEY, Hubbardston, MA (US); Daniel M. GILBERTSON, Millbury, MA (US)

(21) Appl. No.: 15/725,823

(22) Filed: Oct. 5, 2017

Related U.S. Application Data
(60) Provisional application No. 62/404,415, filed on Oct. 5, 2016.
(60) Provisional application No. 62/440,598, filed on Dec. 30, 2016.

(51) Int. Cl. B65D 63/10; F16L 33/03; F16L 33/035; F16L 3/137

(52) U.S. Cl. CPC B65D 63/1072; F16L 3/137; F16L 33/035; F16L 33/03

(57) ABSTRACT

What is disclosed herein is a fastener device, namely a ratcheting clamp, having a reusable clamping feature. The reusable clamping feature may comprise a flexible arm. The flexible arm may comprise overlapping end portions, namely an overlapping inner end and an overlapping outer end along with a locking member for selectively engaging with a top arm. The overlapping outer end may comprise at least one tooth or a plurality of teeth positioned along the overlapping outer end. Further, the fastener device may comprise at least one optional elongated rib on the flexible arm positioned adjacent to the at least one tooth or plurality of teeth of the toothed overlapping outer end that prevents lateral movement of the toothed overlapping outer end when engaged with the locking member and exposed to lateral forces, thereby reducing the likelihood of premature failure of the fastener device. The fastener device disclosed may also utilize a reusable clamping feature. The fastener device may also comprise a cradle and an encapsulation slot for a standard tie to wrap around, thus allowing for a wide range of diameters for the cables, wires, hoses, tubing, or other materials. The fastener device may also comprise a slotted fir tree component, and a retention dish may sit on top of the slotted fir tree component to ensure the fastener device is held in place with vertical forces.

### CROSS REFERENCE TO RELATED APPLICATIONS

This application claims priority to Application No. 62/404,415, filed Oct. 5, 2016 and Application No. 62/440,598, filed Dec. 30, 2016.

### BACKGROUND

What is disclosed herein relates generally to a fastener device. The fastener devices described herein may be used for automotive and other purposes.

Fastener devices, also referred to as ratcheting clamps, are useful for many tasks, such as securing a number of elongated items together or functioning as a band or hose clamp. The fastener devices are hand-applied to the items to be held together. However, fastener devices are susceptible to premature failure when exposed to lateral loads. More specifically, most existing fastener devices are comprised of a generally circular member with overlapping ends, wherein at least one of the overlapping ends further comprises a plurality of spaced apart notches or teeth for mating engagement with a locking member. However, when the toothed overlapping end of such prior art clamps is exposed to lateral forces, the toothed overlapping end has a tendency to prematurely disengage from said locking mechanism, which is both undesirable and potentially dangerous.

Thus, there exists in the art a long felt need for an improved fastener device that is not so easily susceptible to premature failure caused by lateral forces. There is also a long felt need in the art for a fastener device that is both relatively easy to use and inexpensive to manufacture, and that does not require the use of external tools such as screwdrivers, ratchets and the like. Moreover, there exists a need for a fastener device that can retain hoses and cable harnesses. Likewise, a need exists for a fastener device with a reusable clamp to allow for servicing the hoses. There is also a need for a cable harness that will allow for a wide range of cable harness bundle diameters.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The fastener device, which may also be referred to as a ratcheting clamp herein, may be repositionable in both an unlocked and a locked position. The subject matter disclosed and claimed herein, in one aspect thereof, comprises a fastener device comprised of a reusable clamping feature (which may also be referred to as an annular member), a top arm, and a cradle for a tie to attach.

In some embodiments, the reusable clamping feature may comprise a flexible arm which is secured to the top arm. In some embodiments, the reusable clamping feature may comprise an overlapping inner end. The reusable clamping feature may also comprise an overlapping outer end. The overlapping outer end may be used to engage and secure the flexible arm of the reusable clamping feature to the top arm. In some embodiments, the reusable clamping feature may comprise a finger press zone.

In many embodiments, the reusable clamping feature may comprise at least one tooth or a plurality of teeth. At least one tooth from the plurality of teeth may secure the reusable clamping feature to the top arm where the top arm selectively engages one or more of the teeth on the toothed overlapping outer end.

In some embodiments, the top arm may comprise a tab for the release of the flexible arm. In many embodiments, the top arm may comprise a forward tooth for securing the flexible arm to the top arm.

In some embodiments, the fastener device may further comprise an elongated rib (or raised surface) on the reusable clamping feature. The elongated rib may be positioned and located with the at least one or a plurality of teeth. The elongated rib may serve to reduce or prevent lateral movement of the toothed overlapping end when it is at least partially engaged with a locking member and exposed to lateral forces and/or side loads. In other embodiments, the elongated rib may be positioned on the overlapping outer end of the reusable clamping feature. The elongated rib may engage with a channel in the top arm, securing the flexible arm of the reusable clamping feature to the top arm.

In some embodiments, the fastener device may further comprise an encapsulation slot. In one embodiment, a tie will slide through the encapsulation slot and wrap around the cradle to secure the tie to the fastener device as well as an additional item, including but not limited to wires, hoses, tubes, and cables.

In some embodiments, the fastener device may further comprise a slotted tree component. In one embodiment, the slotted fir tree component may comprise a rib or flute feature (referred to as a flute herein, but also be may referred to as a branch or fin) around a slotted tree component. In another embodiment, the slotted fir tree component may comprise an oval shape with a consistent flute thickness around the diameter or outer edges. In another embodiment, the slotted fir tree component may comprise a slotted shape with a consistent flute thickness around the diameter or outer edges. In many embodiments, the slotted fir tree component may be designed to fit into a surface slot. The surface slot may have different shapes, including but not limited to oblong, oval, rectangular, or slotted. In one embodiment, the surface slot is 7×12 mm.

In many embodiments, the slotted fir tree component may also comprise a retention dish, which may sit on top of the slotted fir tree component to ensure the fastener device is held in place with vertical forces.

In another embodiment, the fastener device may comprise a body member to support the top arm and reusable clamping feature.

In some embodiments, the present disclosure relates to a fastener device with a slotted fit tree component. The fastener device disclosed herein may utilize a slotted fir tree component with a reusable clamping feature comprising a flexible arm with at least one tooth or a plurality of teeth, wherein the teeth secure the flexible arm to a top arm. The fastener device may also comprise a body member, a top arm, and a cradle and encapsulating slot for securing the fastener device. The fastener device may be repositionable between an unlocked and a locked position. In some embodiments, the tie will slide through the encapsulation slot and wrap around the cradle. In other embodiments, a retention dish may sit on top of the slotted fir tree component to ensure the fastener device is held in place with vertical forces. In some embodiments, the top arm comprises a tab for the release of the flexible arm. In other embodiments, the flexible arm comprises an internal rib. In other embodiments, the flexible arm comprises a finger press zone to provide the force needed to close the fastener device and engage the fastener device in a locked position. In some embodiments, the fastener device may further comprise an elongated rib (or raised surface) on the reusable clamping feature. The elongated rib may be positioned and located with the at least one tooth or a plurality of teeth.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a top, perspective view of the fastener device in accordance with the disclosed architecture.

FIG. 2 illustrates a bottom, perspective view of the fastener device in accordance with the disclosed architecture.

FIG. 3 illustrates a side, perspective view of the fastener device in accordance with the disclosed architecture.

FIG. 4 illustrates a back, perspective view of the fastener device in accordance with the disclosed architecture.

FIG. 5 illustrates a top, perspective view of the fastener device in accordance with the disclosed architecture in another embodiment of the disclosed fastener.

FIG. 6 illustrates a bottom, perspective view of the fastener device in accordance with the disclosed architecture in another embodiment of the disclosed fastener.

FIG. 7 illustrates a side, perspective view of the fastener device in accordance with the disclosed architecture in another embodiment of the disclosed fastener.

FIG. 8 illustrates a back, perspective view of the fastener device in accordance with the disclosed architecture in another embodiment of the disclosed fastener.

FIG. 9 illustrates a top, perspective view of the fastener device in accordance with the disclosed architecture in another embodiment of the disclosed fastener.

FIG. 10 illustrates a back, perspective view of the fastener device in accordance with the disclosed architecture in another embodiment of the disclosed fastener.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Described herein is a fastener device. The fastener device disclosed herein may be used for a variety of purposes, including but not limited to, automotive, electronic, appliance, and building purposes. The fastener device disclosed herein may be used to bundle cables, wires, hoses, tubing, or other materials. Further, the fastener device may be held in place in order to secure the cables, wires, hoses, tubing, or other materials. The fastener device may be held in place by cable ties, cables, wire, rope, straps, tubing, or any other tie that can secure the fastener device (as used herein, a “tie”). The fastener device may not be as susceptible to premature failure caused by lateral forces, and may be both relatively easy to use and inexpensive to manufacture. Further, the operation of the fastener device described herein may not require the use of external tools such as screwdrivers, ratchets and the like.

The fastener device may comprise: 1) a reusable clamping feature (which may also be referred to as an annular member); 2) a top arm; and 3) a cradle for at least one tie to attach. The reusable clamping feature of the fastener device may provide a user with the ability to secure cables, wires, hoses, tubing, or other materials without removing a tie when the cables, wires, hoses, tubing, or other materials need to be unbundled. As described herein, the fastener device may be repositionable in both an unlocked and a locked position by adjusting the reusable clamping feature.

The reusable clamping feature forms a continuous opening therein and is comprised of a flexible arm which may hold at least one tie. The reusable clamping feature comprises a flexible arm wherein the flexible arm may be secured to the top arm (described below) when the fastener device is in a locked position. When the flexible arm is not secured to the top arm and a gap or opening exists between the reusable clamping feature and the top arm, the fastener device is in an unlocked position. The reusable clamping feature may comprise an overlapping outer end that engages with the top arm in order to secure the flexible arm to the top arm.

In some embodiments, the reusable clamping feature may comprise at least one or a plurality of teeth. The plurality of teeth (or at least one tooth) may be positioned along the outer surface of overlapping outer end. The plurality of teeth (or at least one tooth) may allow for variable sizes of the flexible arm to hold at least one tie when the fastener device is in a locked position. At least one tooth from the plurality of teeth may secure the reusable clamping feature to the top arm where the top arm selectively engages one or more of the teeth on the toothed overlapping outer end.

In some embodiments, the reusable clamping feature may comprise an overlapping inner end. The overlapping inner end may aid in securing the flexible arm of the reusable clamping feature to the top arm.

In other embodiments, the reusable clamping feature also comprises a finger press zone (which may also be referred to as a thumb press zone) positioned along the exterior edge of the reusable clamping feature. In many embodiments, the finger press zone may be near the overlapping outer end. The finger press zone may allow a user to provide the force needed to engage the fastener device in a locked position and engage the fastener device in a locked position. The finger press zone may also provide stability for the user in holding the fastener device. Further, the finger press zone may assist in repositioning fastening device between an unlocked position and a locked position.

In one embodiment, the reusable clamping feature may further comprise an internal rib. The internal rib may be located internally on the flexible arm. The internal rib may protrude inwardly from the interior surface of the reusable clamping feature, and may help to secure the cables, wires, hoses, tubing, or other materials positioned in opening of the reusable clamping feature by digging and/or protruding into the exterior surface of these cables, wires, hoses, tubing, or other materials. Further, the internal rib may keep the convoluted tubing or other ties from pulling through the reusable clamping feature.

The top arm of the fastener device may engage with the flexible arm of the reusable clamping feature in order to secure it in place. The top arm may comprise a tab for release of the flexible arm of the reusable clamping feature. In some embodiments, the top arm may also comprise a forward tooth that may engage with the overlapping outer end of the reusable clamping feature. In some embodiments, the forward tooth positioned on the underside of the top arm may engage with at least one of the teeth of the overlapping outer end. In other embodiments, the top arm may also comprise a rearward tooth. The rearward tooth may also may engage with the overlapping outer end of the reusable clamping feature. In some embodiments, the rearward tooth positioned on the underside of the top arm may engage with at least one of the teeth of the overlapping outer end. The forward tooth and rearward tooth may be spaced such that there may be a gap or channel between them on the underside of the top arm. The forward tooth may be closest to the tab of the top arm. During engagement of the top arm to the reusable clamping feature, the gap or channel may exist between the forward tooth and rearward tooth for receipt of at least one of the teeth from the reusable clamping feature when the fastener device is in a locked position.

The cradle of the fastener device may provide a portion of the fastener device for at least one tie to attach. In some embodiments, the cradle may be attached to the body member. In many embodiments, the cradle may extend outwardly from the fastener device.

In many embodiments, a body member may provide support to both the top arm and reusable clamping feature. The top arm and reusable clamping feature may be attached to the body member in a spaced apart and desired orientation. The orientation and proximity of the top arm and reusable clamping feature, relative to the body member, may permit the two components to engage one another.

In other embodiments, the fastener device may further comprise an elongated rib on the reusable clamping feature. In some embodiments, the elongated rib may be located on the flexible arm near the overlapping outer end. In other embodiments, the elongated rib may be located on the flexible arm at the overlapping outer end. In other embodiments, the elongated rib may be positioned along the outer surface of overlapping outer end and adjacent or within to at least one tooth or the plurality of teeth. In one embodiment, the elongated rib may extend along a length of the outer surface of overlapping outer end and may be positioned between two columns of teeth, wherein the teeth of each of the column are generally aligned in rows. The elongated rib may service to further secure the flexible arm of the reusable clamping feature to the top arm. Further, a channel may be located on the underside of the top arm. The elongated rib may engage with the channel in the top arm to further secure the reusable clamping feature to the top arm. The presence of the elongated rib may prevent lateral movement of the overlapping outer end when exposed to lateral forces and/or side loads, which could result in premature failure of the fastener device, and is both undesirable and potentially dangerous.

In some embodiments, the fastener device may further comprise an encapsulation slot. The encapsulation slot, in conjunction with the cradle, may assist the cradle in attachment. At least one tie may wrap around the cradle 106 and may be further secured using the encapsulation slot. By using the encapsulation slot, a wide range of bundle diameters for cables, wires, hoses, tubing, or other materials may be accommodated.

In some embodiments, the fastener device disclosed herein may utilize a slotted fir tree component. The slotted fir tree component may secure the fastener device to a surface. The slotted fir tree component may be removable or non-removable to a designated surface in which the fastener device is attached.

In many embodiments, the slotted fir tree component may comprise tapered ribs or flutes. The tapered ribs or flutes on each end of the slotted fir tree component may press into the radii of the surface slot in a designated surface to further keep the fastener device stable. Any number of small tapered ribs or flutes can be used as is needed. In some embodiments, the slotted fir tree component may comprise at least two flute features around the slotted tree component. In one embodiment, the slotted fir tree component may comprise a 6 flute feature around a diameter or outer edges of the slotted tree component. In another embodiment, the slotted fir tree component may comprise an oval shape with a consistent flute thickness around the diameter or outer edges. In another embodiment, the slotted fir tree component may comprise a slotted shape with a consistent flute thickness around the diameter or outer edges. In other embodiments, the slotted fir tree component may comprise a rectangular, oblong, or slotted shape with a consistent flute thickness around the diameter or outer edges. In many embodiments, the slotted fir tree component may be designed to fit into a surface slot, which may be oblong, oval, rectangular, or slotted. The surface slot may also be a multitude of sizes, depending on the application. In one embodiment, the surface slot is 7×12 mm.

In some embodiments, the slotted fir tree component may comprise anti-rotation ribs. The anti-rotation ribs may reduce the fastener device from rotating within the designated surface. In some embodiments, the anti-rotation ribs may be located on the flat portion of the slotted fir tree component. In some embodiments, there are two anti-rotation ribs per side to reduce any sort of rotation on the hole with side loads. In other embodiments, there may be any number of anti-rotation ribs as deemed necessary to reduce rotation of the fastener device. Further, the anti-rotation ribs may be any suitable shape and size as is known in the art, depending on the wants and needs of a user and/or manufacturer.

The slotted fir tree component may also comprise a cradle and an encapsulation slot for a tie to wrap around (not shown in the figures). In one embodiment, the tie may be about ⅝ inches+/−0.07 inches (1.5875 cm+/−0.1178 cm).

In many embodiments, the slotted fir tree component may comprise a retention dish. In some embodiments, a retention dish may sit on top of the slotted fir tree component to ensure the fastener device is held in place with vertical forces. Further, a flexible arm may be used to clamp the tie with a tab for release. And, a small cradle may utilize a tie to wrap around the cradle, thus allowing for a wide range of bundle diameters for cables, wires, hoses, tubing, or other materials.

To install the fastener device 100 on an article such as a hose, metal sheet, or another substrate (not shown) and reposition the fastener device from an open position to a closed or locked position would simply place the cables, wires, hoses, tubing, or other materials in opening of the reusable clamping feature and apply pressure to finger press zone in the general direction of top arm, thereby causing overlapping outer end to pass through an opening between the overlapping inner end and top arm. As overlapping outer end passes through the opening between the overlapping inner end and top arm, and the flexible arm may be guided in and received by the opening between the overlapping inner end and top arm channel, and, due to the presence of gap or opening, the forward tooth will engage with the overlapping outer end, including at least one of the plurality of teeth. Further, the rearward tooth may also engage with at least one of the plurality of teeth. Once the fastener device is in the locked position, lateral movement may be reduced or eliminated.

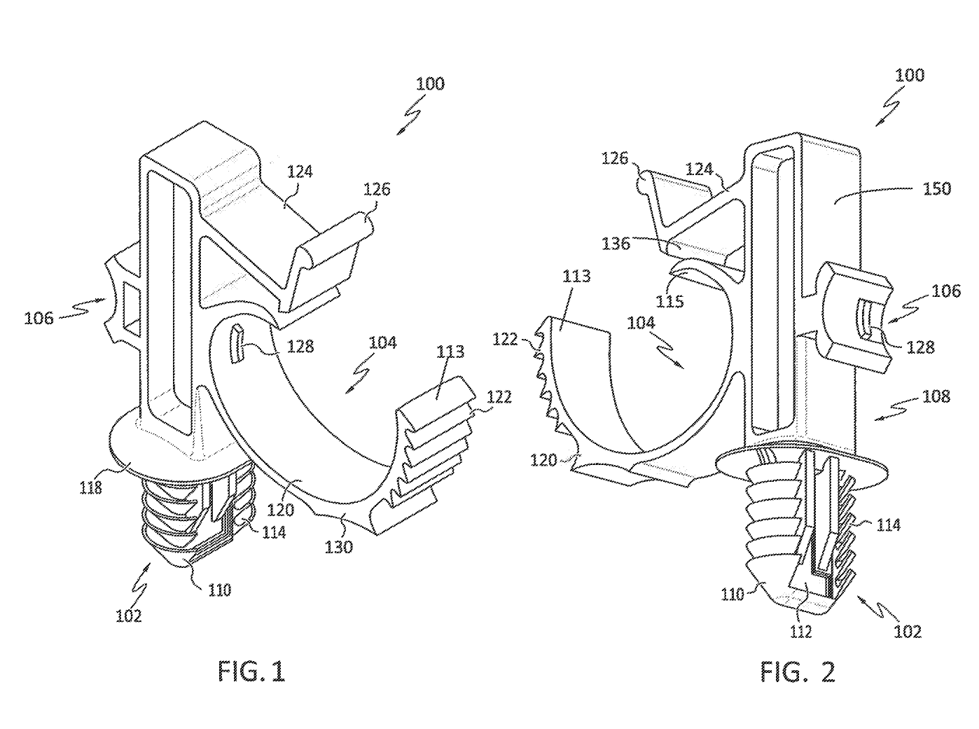

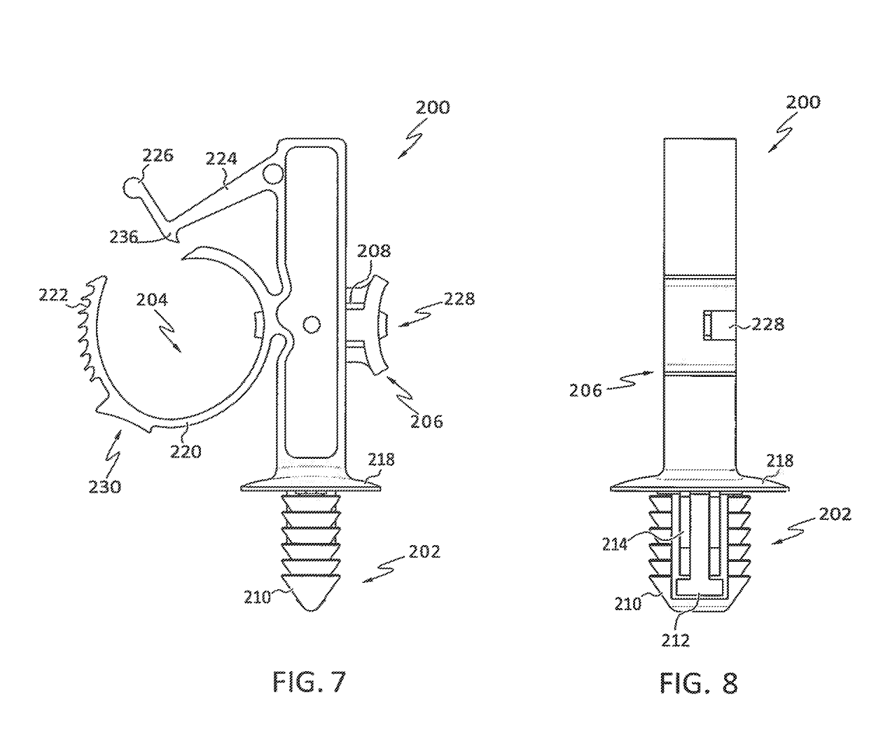

Referring initially to the drawings, FIGS. 1-8 illustrate a fastener device 100.

In FIGS. 1-4, the fastener device 100 may comprise 1) a reusable clamping feature 104 (which may also be referred to as an annular member); 2) a top arm 124; and 3) a cradle 106 (on the body 150) for at least one tie to attach. The reusable clamping feature 104 comprises a flexible arm 120, an overlapping outer end 113, and an overlapping inner end 115. The reusable clamping feature 104 may also comprise an internal rib 128 and a finger press zone 130. Further, the reusable clamping feature 104 may comprise a plurality of teeth 122. In FIGS. 1-4, the top arm 124 comprises a tab 126 and a forward tooth 136.

In some embodiments, the fastener device 100 may utilize a slotted fir tree component 102 with a reusable clamping feature 104 and a cradle 106 and an encapsulation slot 108 for a tie to wrap around. The slotted fir tree design 102 may comprise tapered ribs or flutes 110 on the flat portion 112. In one embodiment, the slotted fir tree component may comprise a 6 flute feature in an oval shape with a consistent flute thickness around the diameter or outer edges. These small tapered ribs or flutes 110 on each end of the slotted fir tree component 102 may press into the radii of the encapsulation slot 108 in the surface to further keep stable. Any number of small tapered ribs or flutes 110 can be used as is needed, as is known in the art. Additionally, the slotted fir tree component 102 may comprise a retention dish 118. The retention dish 118 sits on top of the slotted fir tree component 102 to ensure the fastener device 100 is held in place with vertical forces.

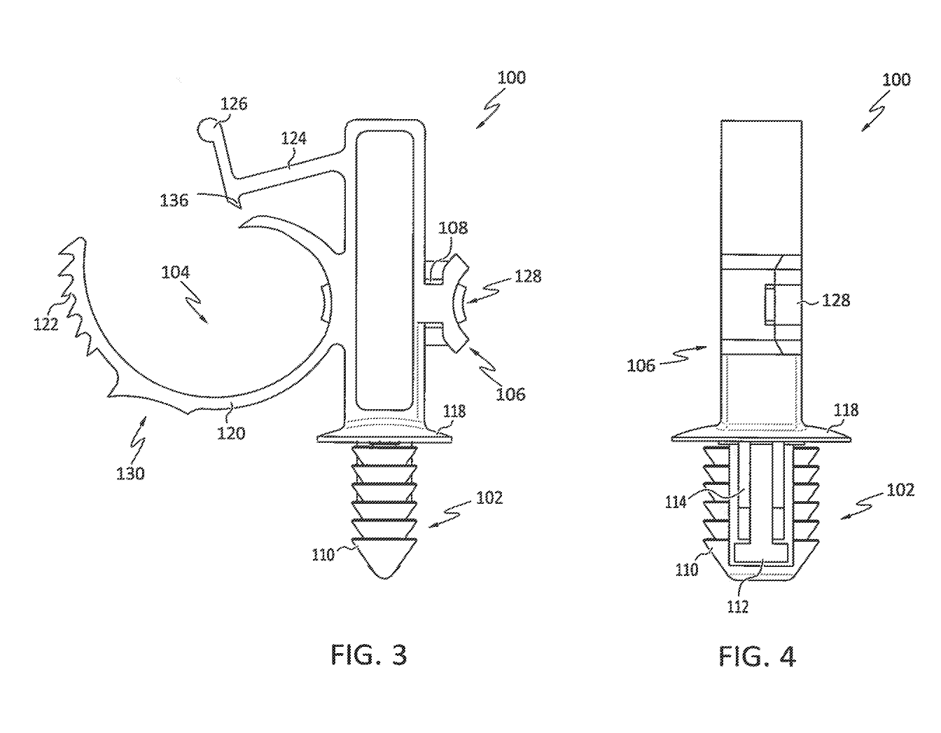

As shown in FIGS. 3-4, the slotted fir tree component 102 is designed to fit into a surface slot. The surface slot may be oblong, oval, rectangular, or slotted, depending on the shape of the slotted fir tree component. The surface slot may also be a multitude of sizes, depending on the application. On the flat portion 112 of the slotted fir tree component 102 there are anti-rotation ribs 114 (at least two per side) to reduce any sort of rotation on the hole with side loads. In many embodiments, there may be at least two anti-rotation ribs 114 per side, but there could be any number of anti-rotation ribs 114 as deemed necessary. Further, the anti-rotation ribs 114 can be any suitable shape and size as is known in the art, depending on the wants and needs of a user and/or manufacturer.

The flexible arm 120 of the clamp may be designed for ties. The plurality of teeth 122 of the flexible arm 120 will be held in place by top arm 124 with tab 126 for release. Internal to the flexible arm 120 is an internal rib 128 to keep the convoluted tie from pulling through. On the flexible arm 120 of the clamp will be a finger press zone 130 in order to engage the fastener device 100 in a locked position the fastener device 100. The finger press zone 130 is not a requirement of the present invention, and one embodiment of the present invention contemplates a fastener device 100 without a finger press zone 130. In some embodiments, the finger press zone may be textured.

In one embodiment, on the opposite side of the flexible arm 120 may be a small cradle 106 for placement of the cable harness (not shown) which will be held in place by a tie (not shown), or other similar securing device. The tie will slide through an encapsulation slot 108 and wrap around the cradle 106, allowing for a wide range of bundle diameters for cables, wires, hoses, tubing, or other materials.

In some embodiments, the fastener device 100 may be cored out as much as possible to keep a consistent wall thickness. In one embodiment, the consistent wall thickness with the tooling split line may have a 2:1 ratio on the part. From the bottom of the retention dish 118 upwards will be the main core/cavity of the tool with everything below the dish (slotted fir tree) will be side action in the tool.

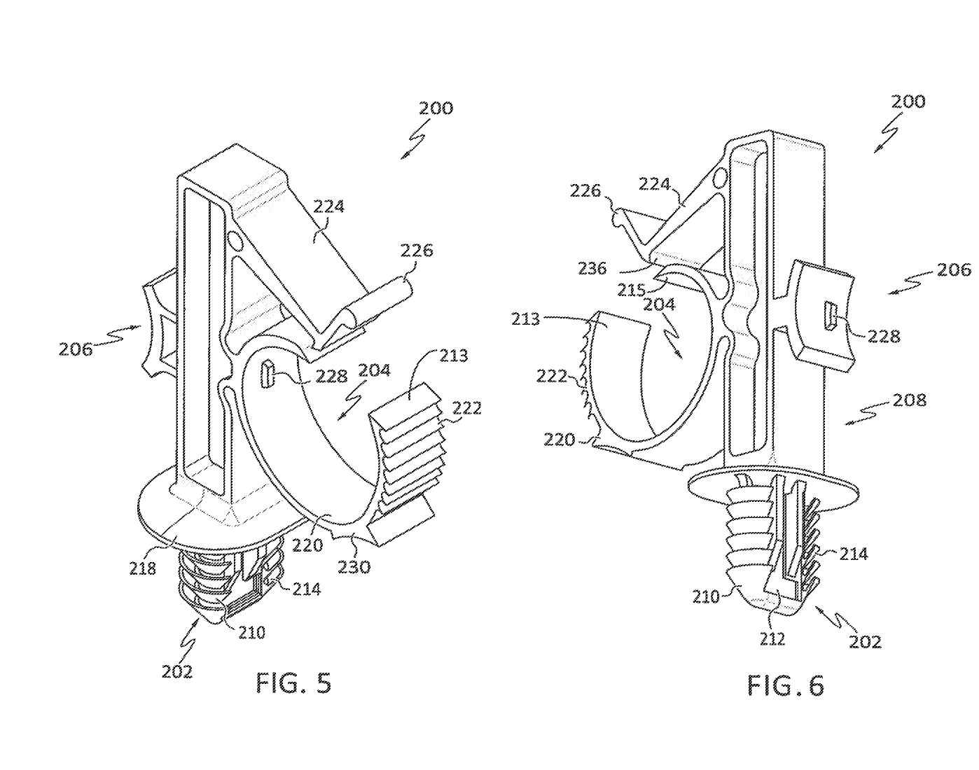

FIGS. 5-8 illustrate another embodiment of the disclosed fastener device 200. In FIGS. 5-8, the height of the fastener has been increased over the fastener provided in FIGS. 1-4. Additionally, the flexible arm 220 as shown in FIGS. 5-7 has been moved to a different angle than what is shown in FIGS. 1-3. The flexible arm 220 in FIGS. 5-8 is cored out more than what is provided in FIGS. 1-4 for molding purposes. For FIGS. 5-8, some parts may have been removed that were shown in FIGS. 1-4 in order to illustrate the fastener device disclosed herein. The parts in FIGS. 5-8 are as follows:
202—slotted fir tree component
204—reusable clamping feature
206—cradle
208—encapsulation slot
210—tapered ribs or flutes (also referred to as fins or branches)
212—flat portion
213—overlapping outer end
214—anti-rotation ribs
218—retention dish
222—teeth
224—top arm
226—tab
228—internal rib
230—finger press zone
236—forward tooth

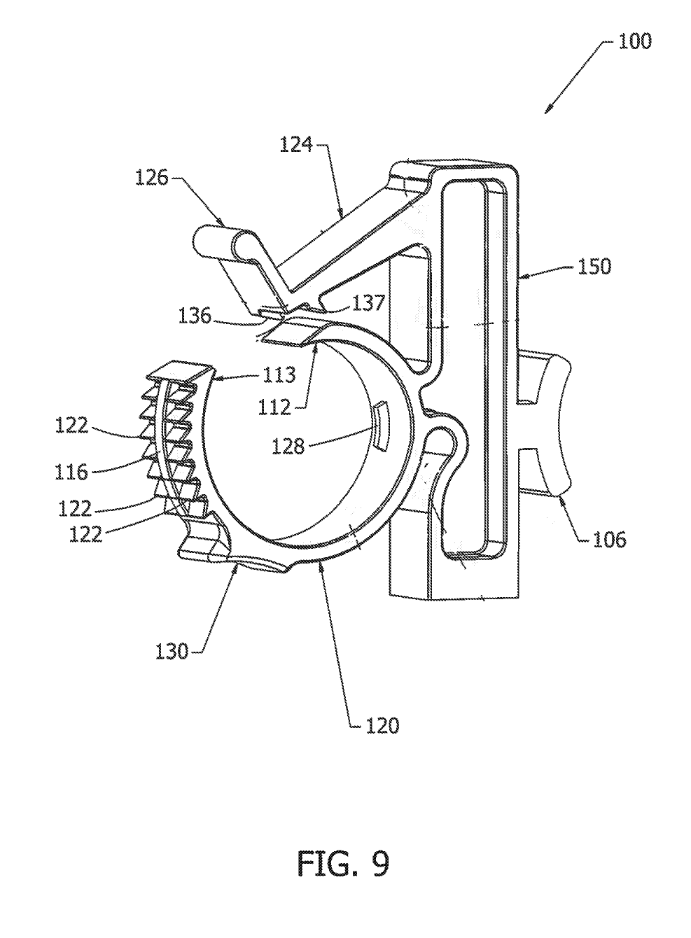

FIG. 9 is similar to FIGS. 1-4, but the elongated rib 116 is shown within the plurality of teeth 122. FIG. 9 also shows both the forward tooth 136 and the rearward tooth 137.

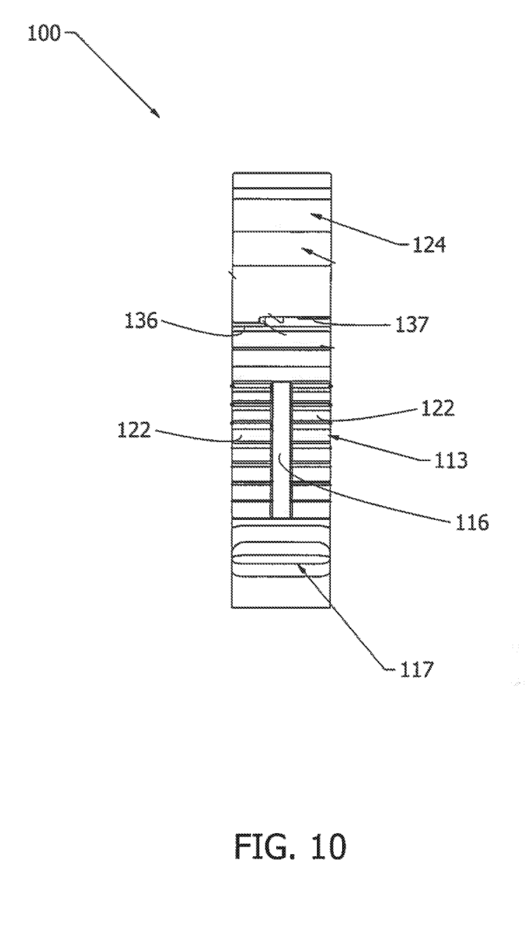

FIG. 10 is a back, perspective view of what is shown in FIG. 9. The elongated rib 116 is located within the plurality of teeth 122 in this embodiment.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fastener device, comprising:
a reusable clamping feature;
a top arm; and
a cradle for at least one tie to attach.

2. The fastener device of claim 1, wherein the fastener device is repositionable between an unlocked and a locked position.

3. The fastener device of claim 1, wherein the reusable clamping feature comprises a flexible arm and wherein the flexible arm is secured to the top arm.

4. The fastener device of claim 1, wherein the reusable clamping feature comprises an overlapping outer end.

5. The fastener device of claim 4, wherein the reusable clamping feature comprises at least one tooth and wherein at least one tooth secures the reusable clamping feature to the top arm.

6. The fastener device of claim 1, wherein the reusable clamping feature comprises an overlapping inner end.

7. The fastener device of claim 1, wherein the reusable clamping feature comprises a finger press zone to engage the fastener device in a locked position.

8. The fastener device of claim 1, wherein the top arm comprises a tab for release of the flexible arm.

9. The fastener device of claim 1, wherein the top arm comprises a forward tooth.

10. The fastener device of claim 1, further comprising an elongated rib on the reusable clamping feature.

11. The fastener device of claim 10, wherein the elongated rib is positioned within at least one tooth.

12. The fastener device of claim 10, wherein the elongated rib engages with a channel in the top arm.

13. The fastener device of claim 1, further comprising an internal rib on the reusable clamping feature.

14. The fastener device of claim 1, further comprising an encapsulation slot.

15. The fastener device of claim 14, wherein the tie will slide through the encapsulation slot and wrap around the cradle.

16. The fastener device of claim 1 further comprising a slotted fir tree component.

17. The fastener device of claim 16, wherein the slotted fir tree component comprises at least two flutes around the slotted fir tree component.

18. The fastener device of claim 16, wherein the slotted fir tree component comprises an oval shape with a consistent flute thickness around the slotted fir tree component.

19. The fastener device of claim 16, wherein the slotted fir tree component comprises a slotted shape with a consistent flute thickness around the slotted fir tree component.

20. The fastener device of claim 16, wherein the slotted fir tree component is designed to fit into a surface slot.

21. The fastener device of claim 20, wherein the surface slot is oblong, oval, rectangular, or slotted.

22. The fastener device of claim 16, wherein the slotted fir tree component comprises anti-rotation ribs on a flat portion of the slotted fir tree component.

23. The fastener device of claim 16, further comprising a retention dish that sits on top of the slotted fir tree component to hold the fastener device in place.

24. The fastener device of claim 1, further comprising a body member to support the top arm and reusable clamping feature.

25. A fastener device, comprising:
a slotted fir tree component;
a reusable clamping feature comprising a flexible arm with at least one tooth, wherein at least one tooth secures the flexible arm to a top arm;
a body member;
a top arm; and
a cradle and an encapsulation slot for securing the fastener device with at least one tie.

26. The fastener device of claim 25, wherein the fastener device is repositionable between an unlocked and a locked position.

27. The fastener device of claim 25, wherein the tie will slide through the encapsulation slot and wrap around the cradle.

28. The fastener device of claim 25, further comprising a retention dish that sits on top of the slotted fir tree component to hold the fastener device in place.

29. The fastener device of claim 25, wherein the top arm comprises a tab for release of the flexible arm.

30. The fastener device of claim 25, wherein the flexible arm comprises an internal rib.

31. The fastener device of claim 25, wherein the flexible arm comprises a finger press zone to engage the fastener device in a locked position.

32. The fastener device of claim 25, further comprising an elongated rib on the reusable clamping feature.

33. The fastener device of claim 32, wherein the elongated rib is positioned within at least one tooth.

34. The fastener device of claim 32, wherein the elongated rib engages with a channel in the top arm.
